(19) United States
(12) Patent Application Publication
(10) Pub. No.: US 2015/0328938 A1
(43) Pub. Date: Nov. 19, 2015

(54) PNEUMATIC TIRE

(71) Applicant: SUMITOMO RUBBER INDUSTRIES LTD., Kobe-shi (JP)

(72) Inventor: Wataru ISAKA, Kobe-shi (JP)

(73) Assignee: SUMITOMO RUBBER INDUSTRIES LTD., Kobe-shi (JP)

(21) Appl. No.: 14/714,736

(22) Filed: May 18, 2015

(30) Foreign Application Priority Data
May 19, 2014 (JP) 2014-103258

(51) Int. Cl. B60C 15/00; B60C 15/024; B60C 15/04

(52) U.S. Cl. CPC B60C 15/0045; B60C 15/04; B60C 15/024; B60C 2015/009

(57) ABSTRACT

A pneumatic tire includes beads, a carcass and a belt. The carcass ply is turned up around the beads from axially inner sides toward axially outer sides respectively such that the carcass ply includes a main portion bridging the beads and turn-up portions positioned on the axially outer sides of the beads and extending in a radially outward direction, respectively, each of the beads includes a core including wires such that the wires extend in a circumferential direction, the core has two or more strands and turns which are three times a number of the strands or more, the wires have a radially outer edge positioned on a radially inner side of a radially outer edge of a flange of a normal rim when the pneumatic tire is mounted on the normal rim, and each of the turn-up portions has an outer-edge part overlapping an edge portion of the belt.

### CROSS-REFERENCE TO RELATED APPLICATIONS

The present application is based upon and claims the benefit of priority to Japanese Patent Application No. 2014-103258, filed May 19, 2014, the entire contents of which are incorporated herein by reference.

### BACKGROUND OF THE INVENTION

1. Field of the Invention

The present invention relates to a pneumatic tire.

2. Description of Background Art JP2001-97010A describes a tire having a core that is set tall in a radial direction. JP2010-137637A describes a tire with a core where the radial height of the core is set to be lower than the height of the flange of a rim. The entire contents of these publications are incorporated herein by reference.

### SUMMARY OF THE INVENTION

According to one aspect of the present invention, a pneumatic tire includes a pair of beads, a carcass including a carcass ply, and a belt positioned on a radially outer side of the carcass. The carcass ply is turned up around the beads from axially inner sides toward axially outer sides respectively such that the carcass ply includes a main portion bridging the pair of beads and turn-up portions positioned on the axially outer sides of the beads and extending in a radially outward direction, respectively, each of the beads includes a core including wires such that the wires extend in a circumferential direction, the core has two or more strands and turns which are three times a number of the strands or more, the wires have a radially outer edge positioned on a radially inner side of a radially outer edge of a flange of a normal rim when the pneumatic tire is mounted on the normal rim, and each of the turn-up portions has an outer-edge part overlapping an edge portion of the belt.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a cross-sectional view showing part of a motorcycle tire according to an embodiment of the present invention;

FIG. 2 is an enlarged cross-sectional view of the core of the tire in FIG. 1;

FIG. 3 is an enlarged cross-sectional view showing part of the tire in FIG. 1; and

FIG. 4 is an enlarged cross-sectional view showing another part of the tire in FIG. 1.

### DETAILED DESCRIPTION OF THE EMBODIMENTS

The embodiments will now be described with reference to the accompanying drawings, wherein like reference numerals designate corresponding or identical elements throughout the various drawings.

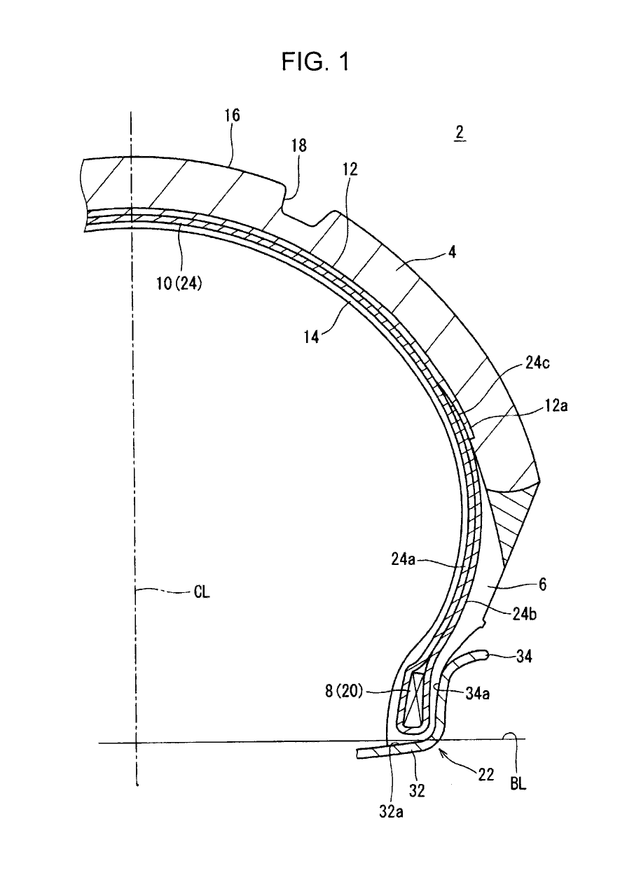

FIG. 1 is a cross-sectional view showing part of tire 2 according to an embodiment of the present invention. Tire 2 is mounted on a motorcycle. In FIG. 1, longitudinal directions are radial directions of tire 2, lateral directions are axial directions of tire 2, and directions perpendicular to the drawing sheet are circumferential directions of tire 2. Chain line (CL) in FIG. 1 indicates the equatorial plane of tire 2. Tire 2 is substantially symmetrical to the equatorial plane. Tire 2 has tread 4, sidewall 6, bead 8, carcass 10, belt 12 and inner liner 14. Tire 2 is a tubeless pneumatic tire.

Tread 4 is made of a crosslinked rubber and shaped to protrude in a radially outward direction. Tread 4 includes tread surface 16 which makes contact with the ground. Grooves 18 on tread surface 16 form tread patterns. It is an option for tire 2 not to have grooves 18 formed on tread surface 16.

Sidewall 6 extends from the edge of tread 4 in an approximately radially inward direction. Sidewall 6 is made of a crosslinked rubber. Sidewall 6 absorbs impact from the ground by warping. Sidewall 6 prevents damage to carcass 10.

Bead 8 is positioned on the radially inner side of sidewall 6. Bead 8 has core 20. Core 20 is formed in a ring shape. Bead 8 does not include an apex. However, it is an option for bead 8 to have an apex. When bead 8 has an apex, the apex extends from core 20 in a radially outward direction. An apex is made of a crosslinked hard rubber. For example, a sheet-type apex may extend from core 20 in a radially outward direction.

Solid line (BL) in FIG. 1 indicates the bead base line. The bead base line specifies the rim diameter of normal rim 22 on which tire 2 is mounted (see JATMA). The bead base line extends in an axial direction.

Carcass 10 extends along the inner side of tread 4 and sidewall 6 and is bridged between beads 8 on both sides. Carcass 10 is made of carcass ply 24. Carcass ply 24 is wound around bead 8 from the axially inner side to the outer side.

Carcass ply 24 is wound around bead 8 to form main portion (24a) and turn-up portion (24b). Main portion (24a) extends along the inner side of tread 4 and sidewall 6 to bridge one bead 8 and the other bead 8. Turn-up portion (24b) is laminated on the axially outer side of bead 8 and on the outer side of main portion (24a). Radially outer-edge part (24c) of turn-up portion (24b) overlaps belt 12. Outer-edge part (24c) of turn-up portion (24b) is positioned on the inner side of belt 12. Outer-edge part (24c) is sandwiched between main portion (24a) and belt 12.

Although not shown in the drawings, carcass ply 24 is made of carcass cords and a topping rubber. The carcass cords incline relative to the equatorial plane. The absolute value of the inclination angle relative to the equatorial plane is at least 60 degrees but no greater than 90 degrees. In other words, tire 2 is a radial tire. The carcass cords are usually made of organic fibers. Preferred organic fibers are polyester fibers, nylon fibers, rayon fibers, polyethylene naphthalate fibers, and aramid fibers.

Belt 12 is positioned on the radially outer side of carcass 10. Belt 12 is laminated on carcass 10. Edge part (12a) of belt 12 is positioned on the axially outer side of outer-edge part (24c) of carcass ply 24. Edge part (12a) is laminated on outer-edge part (24c). Belt 12 reinforces carcass 10.

Belt 12 is made of cords and a topping rubber, though not shown in the drawings. Cords are wound to be helical. Belt 12 extends substantially in a circumferential direction. The angle of cords relative to the circumferential direction is 5 degrees or less, preferably 2 degrees or less. Cords are made by intertwining multiple steel cords, for example. A steel cord is made by intertwining multiple steel filaments. For example, a steel cord is formed by intertwining three thin steel filaments, and a cord is obtained by intertwining three steel cords. The structure of such a cord is referred to as a so-called 3×3 structure. Those cords are wound in a circumferential direction. Those cords may also be made by using organic fibers. Examples of organic fibers are nylon fibers, polyester fibers, rayon fibers, polyethylene naphthalate fibers and aramid fibers. Also, in belt 12, numerous cords arranged parallel to each other may incline relative to the equatorial plane. The absolute value of the inclination angle is, for example, 10 or greater but 35 degrees or less.

Inner liner 14 is bonded to the internal surface of carcass 10. Inner liner 14 is made of a crosslinked rubber. Inner liner 14 is formed by using a rubber with excellent air impermeability. Inner liner 14 works to maintain the inflation pressure of tire 2.

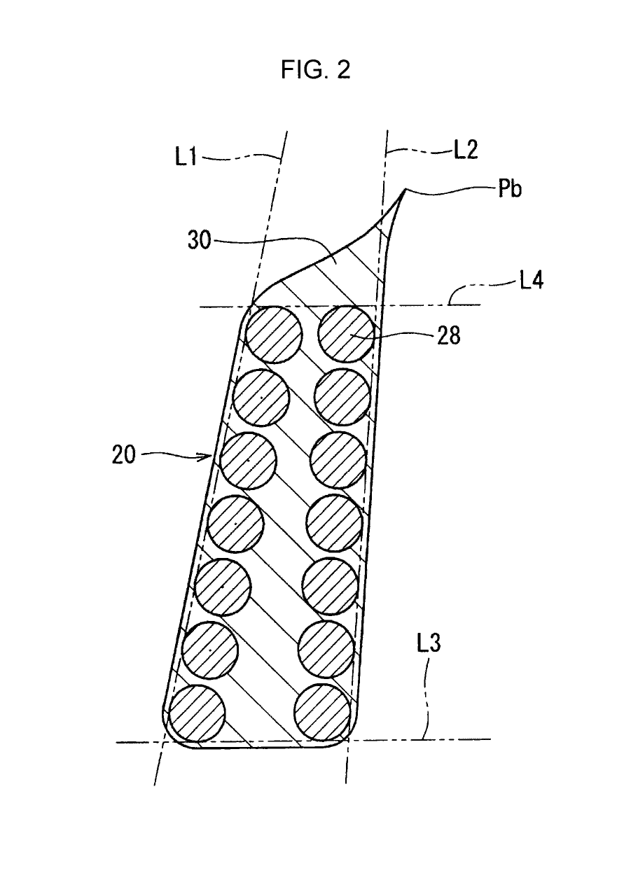

As shown in FIG. 2, bead 8 is formed with core 20 containing wire 28 and crosslinked rubber 30. The number of rows of wire 28 arranged in an axial direction is the number of strands in core 20. The number of strands in core 20 is two. The number of layers of wire 28 arranged in a radial direction is the number of turns in core 20. The number of turns in core 20 is seven.

The number of strands in core 20 is two or more, and the number of turns is at least three times the number of strands in tire 2. Also, core 20 is set to have a radial height that is greater than the axial width. The radial outer edge of wire 28 in core 20 is positioned on the inner side of the radially outer edge of flange 34. Core 20 contributes to enhancing riding comfort.

As shown in FIG. 2, dashed line (L1) is a straight line that passes through the axially innermost side along the axial inner edge of wire 28 arranged in a radial direction. Dashed line (L2) is a straight line that passes through the axially outermost side along the axial outer edge of wire 28 arranged in a radial direction. Dashed line (L3) is a straight line that passes through the radially innermost side along the radially inner edge of wire 28 arranged in an axial direction. Dashed line (L4) is a straight line that passes through the radially outermost side along the radially outer edge of wire 28 arranged in an axial direction.

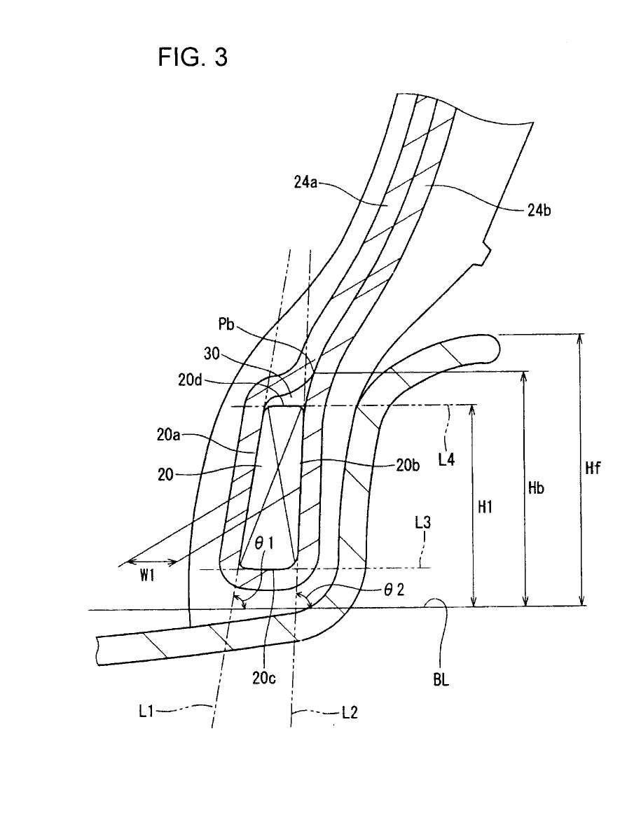

As shown in FIG. 3, straight line (L1) extends along axially inner-side surface (20a) of core 20. Straight line (L2) extends along axially outer-side surface (20b) of core 20. Straight lines (L1, L2) incline from the axially inner side to the outer side in a radially outward direction. Straight line (L3) extends along radially lower surface (20c) of core 20, and straight line (L4) extends along radially upper surface (20d) of core 20.

Double-headed arrow (01) in FIG. 3 indicates the angle made by the bead base line and straight line (L1). Angle (01) is the angle at which the axially inner side of core 20 inclines. Double-headed arrow (02) indicates the angle made by the bead base line and straight line (L2). Angle (02) is the angle at which the axially outer side of core 20 inclines. Inclination angles (θ1, θ2) are each set to be smaller than 90 degrees.

Double-headed arrow (W1) indicates the axial width of core 20. Width (W1) is measured as the distance between straight lines (L1, L2). Width (W1) of tire 2 decreases from the radially inner side of core 20 toward the outer side. The region surrounded by straight lines (L1, L2, L3, L4) is made trapezoidal in tire 2.

As shown in FIG. 3, carcass ply 24 is wound around core 20 from the axially inner side toward the outer side. On the radially outer side of core 20, main portion (24a) and turn-up portion (24b) overlap each other. Crosslinked rubber 30 is surrounded by upper surface (20d) of core 20, main portion (24a) and turn-up portion (24b). Because of crosslinked rubber 30, separation of core 20 and carcass ply 24 is suppressed. Crosslinked rubber 30 is made of the same material as that used for the topping rubber of carcass ply 24. However, crosslinked rubber 30 may be made using different material from that used for the topping rubber of carcass ply 24.

Point (Pb) in FIG. 3 indicates the radially outer edge of bead 8. Bead 8 does not include an apex made of a crosslinked hard rubber.

As shown in FIG. 1, tire 2 is mounted on rim 22. Rim 22 includes base 32 and flange 34. Flange 34 extends from the axially outer edge of base 32 in a radially outward direction. Base 32 has seat surface (32a) that abuts tire 2. Flange 34 has abutting surface (34a) that abuts tire 2.

In FIG. 3, double-headed arrow (H1) indicates the height of core 20. Double-headed arrow (Hb) indicates the height of bead 8. Double-headed arrow (Hf) indicates the height of flange 34 of rim 22. Heights (H1, Hb, Hf) are radial distances measured in a straight line.

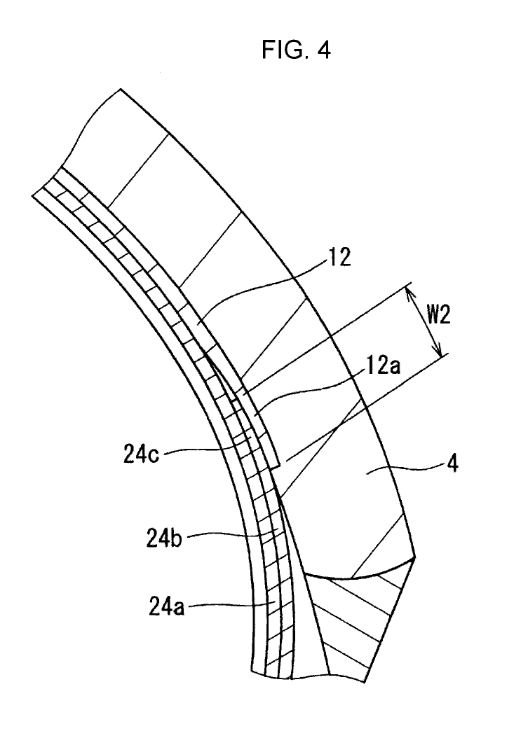

Double-headed arrow (W2) in FIG. 4 indicates the width where edge part (12a) of belt 12 overlaps outer-edge part (24c) of carcass ply 24. Width (W2) is referred to as an overlapping width of edge part (12a) of belt 12 and outer-edge part (24c) of carcass ply 24. Overlapping width (W2) is measured along the surface where edge part (12a) is bonded to outer-edge part (24c).

In tire 2, turn-up portion (24b) of carcass ply 24 overlaps main portion (24a) to reinforce sidewall 6. Carcass ply 24 contributes to enhancing the rigidity of the region from core 20 to edge part (12a) of belt 12. Moreover, outer-edge part (24c) is fixed by edge part (12a) and outer-edge part (24c) which overlap each other. The rigidity of the region from core 20 to edge part (12a) of belt 12 is significantly improved compared with a tire without such a fixed structure.

By combining core 20 and carcass ply 24 structured as above, riding comfort and steering stability of tire 2 are both enhanced. In tire 2, there is no need to provide a reinforcement-rubber layer that extends beyond the radially outer edge of flange 34 in a radially outward direction from core 20. Tire 2 exhibits sufficient rigidity without having a reinforcement layer. The combination of core 20 and carcass 24 contributes to the light weight of tire 2.

In addition, outer-edge part (24c) is positioned on the radially inner side of edge part (12a) in tire 2. Outer-edge part (24c) is sandwiched between main portion (24a) and edge part (12a). Edge part (12a) is secured even more strongly. Carcass ply 24 and belt 12 are integrated with each other. Accordingly, tire 2 exhibits even higher rigidity.

To securely fix outer-edge part (24c) to edge part (12a), overlapping width (W2) between outer-edge part (24c) and edge part (12a) is preferred to be 5 mm or greater. More preferably, overlapping width (W2) is 10 mm or greater, especially preferably 15 mm or greater. On the other hand, if tire 2 has a greater overlapping width (W2), the rigidity of tread 4 increases too much. Overlapping width (W2) is preferred to be 20 mm or less, more preferably 15 mm or less.

Inclination angles (θ1, θ2) in tire 2 are each preferred to be 89 degrees or smaller. Core 20 inclines from the axially inner side to the outer side in a radially outward direction. Because of such inclination, warping in sidewall 6 is less likely to be inhibited, and the riding comfort of tire 2 will not decrease. From those viewpoints, inclination angles (01, 02) are more preferably 85 degrees or smaller, especially preferably 80 degrees or smaller.

Meanwhile, greater inclination angles (θ1, θ2) bring excellent steering stability to tire 2. From such a viewpoint, inclination angles (θ1, θ2) are preferred to be 50 degrees or greater, more preferably 55 degrees or greater, especially preferably 60 degrees or greater.

In tire 2, the axial width of core 20 decreases from the radially inner side toward the outer side. In other words, inclination angle (θ1) is set smaller than inclination angle (02). Accordingly, the rigidity of core 20 decreases from the radially inner side toward the outer side. Core 20 is far less likely to inhibit warping in sidewall 6. Core 20 contributes to enhancing both steering stability and riding comfort. From those viewpoints, the cross-sectional shape of core 20 is preferred to be trapezoidal. The cross-sectional shape of core 20 here indicates the shape of the region surrounded by straight lines (L1, L2, L3, L4). The cross-sectional shape is the shape of a cross section perpendicular relative to a circumferential direction.

To form a structure where the axial width of core 20 decreases from the radially inner side toward the outer side, the number of strands on the radially inner side of core 20 may be set greater than the number of strands on the radially outer side, for example. Alternatively, the distance between the wires axially adjacent on the radially inner edge of core 20 may be set greater than the distance between the wires axially adjacent on the radially outer edge.

### EXAMPLES

The effects according to an embodiment of the present invention are made evident by the examples below. However, the present invention is not limited to the descriptions of the examples below.

### Example 1

A tire was prepared to have the structure shown in FIG. 1. Overlapping width (W2), core height (H1) and inclination angles (θ1, θ2) of the tire are specified in Table 1. The tire size was “180/55ZR17.”

### Comparative Example 1

The turn-up edge of the carcass ply did not extend to the edge part of the belt, but was laminated on the main portion of the carcass ply. Inclination angles (θ1, θ2) were specified as shown in Table 1. The rest of the tire was set the same as in Example 1.

### Example 2 and 3

Tires were each prepared the same as in Example 1 except that inclination angles (θ1, θ2) were specified as shown in Table 1.

### Example 4 and 6

Tires were each prepared the same as in Example 1 except that overlapping width (W2) and inclination angles (θ1, θ2) were specified as shown in Table 1 and 2 respectively.

### Example 5 and Comparative Example 2

Tires were each prepared the same as in Example 1 except that height (H1) and inclination angles (θ1, θ2) were specified as shown in Table 2.

### Comparative Example 3

The tire was prepared the same as in Comparative Example 1 except that height (H1) was specified as shown in Table 2.

### Riding Comfort

Each tire was mounted on a rim with a size of 17M/C×MT5.50, and air was filled in the tire at an inflation pressure of 290 kPa. The flange height (Hf) of the rim was 15 mm. A load of 1.3 kN was exerted on the tire. When the tire was driven over a bump (5×5 mm), the reaction force and the time until the tire was restored to its normal state were measured. The results are shown in Table 1 and 2 as indices. The indices are shown as the value obtained in Comparative Example 1 being set as a base value of 3.0. The greater the value is, the better the evaluation result is.

### Steering Stability

Each tire was mounted on a rim with a size of 17M/C×MT5.50, and air was filled in the tire at an inflation pressure of 290 kPa. The rim is the same as that used for evaluation of riding comfort. Each tire was mounted on a commercially available motorcycle with a displacement of 1300 cm³ (cc). A rider ran the motorcycle on a racing circuit and evaluated steering stability. The results are shown in Table 1 and 2 as indices. The indices are shown as the value obtained in Comparative Example 1 being set as a base value of 100. The greater the value is, the better the evaluation result is.

TABLE 1
Evaluation Results

| | Comp. | Example | Example | Example | Example |
|---|---|---|---|---|---|
| | Example 1 | 2 | 1 | 3 | 6 |
| Overlapping | none | 15 | 15 | 15 | 20 |
| width W2 (m m) | | | | | |
| Core height | 11 | 11 | 11 | 11 | 11 |
| H 1 (m m) | | | | | |
| Inclination | 90 | 60 | 60 | 85 | 85 |
| angle θ1 (*) | | | | | |
| Inclination | 90 | 60 | 70 | 85 | 85 |
| angle θ2 (*) | | | | | |
| Riding comfort | 100 | 110 | 115 | 105 | 105 |
| Steering stability | 3.0 | 3.5 | 5.0 | 4.0 | 3.5 |

TABLE 2
Evaluation Results

| | Example | Example | Comp. | Comp. |
|---|---|---|---|---|
| | 4 | 5 | Example 2 | Example 3 |
| Overlapping width W2 (m m) | 5 | 15 | 15 | none |
| Core height H 1 (m m) | 11 | 14 | 15 | 15 |
| Inclination angle θ1 (*) | 85 | 85 | 85 | 90 |
| Inclination angle θ2 (*) | 85 | 85 | 85 | 90 |
| Riding comfort | 110 | 105 | 85 | 90 |
| Steering stability | 3.5 | 4.5 | 3.0 | 2.5 |

As shown in Table 1 and 2, tires in the examples show higher evaluation results than tires in the comparative examples. The excellence according to an embodiment of the present invention is evident from those evaluation results.

The structures described above are not limited to tires for motorcycles, but can be employed in any pneumatic tire having a carcass, belt and core.

A core contributes to enhancing the rigidity of the tire. Enhanced rigidity improves the steering stability of the tire. However, enhanced rigidity lowers riding comfort.

By limiting the height of the core, the riding comfort of the tire is improved. However, the rigidity of the tire is lowered by the limited height of the core. Lowered rigidity reduces steering stability.

As described above, it is not easy to enhance both the riding comfort and the steering stability of a pneumatic tire. A pneumatic tire according to an embodiment of the present invention exhibits both excellent steering stability and riding comfort.

A pneumatic tire according to one aspect of the present invention is provided with a pair of beads, a carcass and a belt. The carcass contains a carcass ply. The carcass ply is turned up around each bead from the axially inner side toward the outer side. The turn-up structure forms a main portion bridging one bead to the other bead and turn-up portions positioned on the axially outer side of the respective beads to extend in a radially outward direction. The beads each include a core containing a wire that extends in a circumferential direction. The number of strands in the core is at least two. The number of turns is at least three times the number of strands in the core. When the tire is mounted on a normal rim, the radially outer edge of the wire is positioned on the radially inner side of the radially outer edge of the flange of a normal rim. The outer-edge part of the turn-up portion overlaps the edge part of the belt.

The outer-edge part of the turn-up portion is preferred to be positioned on the radially inner side of the edge part of the belt.

The width where the outer-edge part of the turn-up portion overlaps the edge part of the belt is preferred to be at least 5 mm but no greater than 20 mm.

The inclination angle (θ1) of the core on its axially inner side and the inclination angle (θ2) of the core on its axially outer side are each preferred to be at least 50 degrees but no greater than 89 degrees to a cross section perpendicular with respect to a circumferential direction.

The axial width of the core is preferred to decrease from the radially inner side toward the outer side.

The shape of the core on a cross section perpendicular with respect to a circumferential direction is preferred to be trapezoidal.

The number of strands on the radially inner side of the core is preferred to be set greater than the number of strands on the radially outer side of the core.

The distance between wires axially adjacent to each other at the radially inner edge of the core is preferred to be set greater than the distance between wires axially adjacent to each other at the radially outer edge of the core.

When the tire is mounted on a normal rim, the tire is preferred not to have a reinforcement-rubber layer that extends beyond the radially outer edge of the flange of the normal rim in a radially outward direction from the core.

In a tire according to an embodiment of the present invention, steering stability is enhanced by combining the structures of the core and the carcass. Since the core is positioned on the radially inner side of the outer edge of the flange of a normal rim, riding comfort is not sacrificed. A tire according to an embodiment of the present invention exhibits excellent steering stability and riding comfort.

Obviously, numerous modifications and variations of the present invention are possible in light of the above teachings. It is therefore to be understood that within the scope of the appended claims, the invention may be practiced otherwise than as specifically described herein.

What is claimed is:

1. A pneumatic tire, comprising:
a pair of beads;
a carcass comprising a carcass ply; and
a belt positioned on a radially outer side of the carcass,
wherein the carcass ply is turned up around the beads from axially inner sides toward axially outer sides respectively such that the carcass ply includes a main portion bridging the pair of beads and turn-up portions positioned on the axially outer sides of the beads and extending in a radially outward direction, respectively, each of the beads includes a core comprising a plurality of wires such that the plurality of wires extends in a circumferential direction, the core has at least two strands and a plurality of turns which is at least three times a number of the strands, the plurality of wires has a radially outer edge positioned on a radially inner side of a radially outer edge of a flange of a normal rim when the pneumatic tire is mounted on the normal rim, and each of the turn-up portions has an outer-edge part overlapping an edge portion of the belt.

2. A pneumatic tire according to claim 1, wherein the outer-edge part of each of the turn-up portions is positioned on a radially inner side of the edge portion of the belt.

3. The pneumatic tire according to claim 1, wherein the outer-edge part of each of the turn-up portions is overlapping the edge portion of the belt in a width of from 5 mm or greater to 20 mm or less.

4. The pneumatic tire according to claim 1, wherein the core has an inclination angle θ1 on an axially inner side of the core and an inclination angle θ2 on an axially outer side of the core, each of which is in a range of from 50 degrees or more to 89 degrees or less in a cross section perpendicular with respect to a circumferential direction.

5. The pneumatic tire according to claim 1, wherein the core has an axial width which decreases from a radially inner side of the core toward a radially outer side of the core.

6. The pneumatic tire according to claim 1, wherein the core has a trapezoidal shape on a cross section perpendicular with respect to a circumferential direction.

7. The pneumatic tire according to claim 1, wherein the core has a number of strands on a radially inner side of the core, which is set greater than a number of strands on a radially outer side of the core.

8. The pneumatic tire according to claim 1, wherein the plurality of wires is formed such that a distance between wires axially adjacent to each other at a radially inner edge of the core is greater than a distance between wires axially adjacent to each other at a radially outer edge of the core.

9. The pneumatic tire according to claim 1, wherein the pneumatic tire does not have a reinforcement-rubber layer extending beyond the radially outer edge of the flange of the normal rim in the radially outward direction from the core, when the pneumatic tire is mounted on the normal rim.

10. The pneumatic tire according to claim 2, wherein the outer-edge part of each of the turn-up portions is overlapping the edge portion of the belt in a width of from 5 mm or greater to 20 mm or less.

11. The pneumatic tire according to claim 2, wherein the core has an inclination angle θ1 on an axially inner side of the core and an inclination angle θ2 on an axially outer side of the core, each of which is in a range of from 50 degrees or more to 89 degrees or less in a cross section perpendicular with respect to a circumferential direction.

12. The pneumatic tire according to claim 2, wherein the core has an axial width which decreases from a radially inner side of the core toward a radially outer side of the core.

13. The pneumatic tire according to claim 2, wherein the core has a trapezoidal shape on a cross section perpendicular with respect to a circumferential direction.

14. The pneumatic tire according to claim 2, wherein the core has a number of strands on a radially inner side of the core, which is set greater than a number of strands on a radially outer side of the core.

15. The pneumatic tire according to claim 2, wherein the plurality of wires is formed such that a distance between wires axially adjacent to each other at a radially inner edge of the core is greater than a distance between wires axially adjacent to each other at a radially outer edge of the core.

16. The pneumatic tire according to claim 2, wherein the pneumatic tire does not have a reinforcement-rubber layer extending beyond the radially outer edge of the flange of the normal rim in the radially outward direction from the core, when the pneumatic tire is mounted on the normal rim.

17. The pneumatic tire according to claim 3, wherein the core has an inclination angle θ1 on an axially inner side of the core and an inclination angle θ2 on an axially outer side of the core, each of which is in a range of from 50 degrees or more to 89 degrees or less in a cross section perpendicular with respect to a circumferential direction.

18. The pneumatic tire according to claim 3, wherein the core has an axial width which decreases from a radially inner side of the core toward a radially outer side of the core.

19. The pneumatic tire according to claim 3, wherein the core has a trapezoidal shape on a cross section perpendicular with respect to a circumferential direction.

20. The pneumatic tire according to claim 3, wherein the core has a number of strands on a radially inner side of the core, which is set greater than a number of strands on a radially outer side of the core.
